(19) United States
(12) Patent Application Publication
(10) Pub. No.: US 2009/0212974 A1
(43) Pub. Date: Aug. 27, 2009

(54) Parking aid notification by vibration

(75) Inventors: Tanemichi Chiba, Novi, MI (US); Hiroto Uesaka, West Bloomfield, MI (US); Michael A. Wiegand, Birmingham, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/072,218

(22) Filed: Feb. 25, 2008

(51) Int. Cl. B60Q 1/48

(52) U.S. Cl. 340/932.2; 340/425.5

(57) ABSTRACT

A vehicle parking aid system may employ a seat, a steering wheel, and at least one or more sensors disposed about the periphery of the vehicle to detect objects outside of the vehicle. Additionally, indicators, which may be vibratory, may be disposed in a component such as a seat and/or the steering wheel of the vehicle and are associated with the sensor(s). The vehicle component may communicate with a driver of the vehicle via the at least one indicator, which may vibrate when the at least one sensor detects an object near the vehicle and sensor. The indicators may be selectively orientated in the seat and steering wheel and activated by the sensors in a manner that indicates a location of the detected object relative to the vehicle.

### FIELD

The present disclosure relates to a parking aid notification system for a vehicle and, more particularly, to a parking aid system using tactile feedback to communicate the presence of an object detected near the vehicle.

### BACKGROUND

The statements in this section merely provide background information related to the present disclosure and may not constitute prior art. Some vehicles are equipped with a parking aid system that may provide visual and audible assistance to a driver while parking a vehicle. Such a visual and audible parking aid system may include sensors located at a front and a rear of the vehicle that can detect an object when the object is in range of the sensor. The parking aid system can communicate the presence of the detected object to the driver to help prevent a collision between the vehicle and the object. Such a parking aid system may be particularly helpful when the driver is attempting to parallel park, as blind spots immediately in front of and behind the vehicle often make judging a distance or distances from other parked vehicles difficult.

Current parking aid systems, however, typically use one or a combination of visual and audible warnings to alert a driver that an object has been detected. For example, one such parking aid system may simply sound an alarm to warn the driver that an object has been detected proximate to the vehicle. These audible systems, however, generally do not provide feedback to the driver regarding a location of the detected object. Accordingly, the driver must still visually determine the location of the detected object, such as looking around with his or her eyes while turning his or her head before proceeding, which distracts the driver. Audible systems may also unnecessarily cause concern for passengers in the vehicle. Moreover, audible systems may not be particularly useful for hearing impaired drivers of the vehicle.

Other parking aid systems may take and/or record images at various locations around a vehicle and display the images on a monitor, which is viewable by the driver. This type of system may indicate a location of a detected object on the monitor. These systems, however, may require the driver to concentrate on and evaluate the image displayed on the monitor to determine the specific location of the detected object. This level of driver analysis may cause the driver to over-focus on the image and ignore other conditions around the vehicle. Such driver focus may cause the driver to misinterpret the image and ignore or not detect other objects in or near the vehicle path.

Accordingly, a parking aid system that detects objects within a predetermined distance from the vehicle and provides tactile feedback to a driver of the vehicle is desirable. Moreover, a parking aid system that generally or specifically indicates the location of the detected object, in addition to tactile feedback, is further desirable.

### SUMMARY

A parking aid system for a vehicle having a seat and a steering wheel is provided and may include at least one object detecting sensor disposed on the vehicle and operable to detect an object around a periphery of the vehicle and at least one indicator, such as a tactile indicator, disposed in a component, such as a seat or steering wheel, of the vehicle and associated with the at least one sensor. A vehicle component may communicate with a driver of the vehicle and the at least one indicator may vibrate when the at least one sensor detects an object near the vehicle. The vehicle component may be a steering wheel or a seat, for example. Further, the parking aid system may include multiple sensors and multiple indicators, which may be selectively orientated on or in the vehicle and activated in a manner that indicates a location of the detected object relative to the vehicle position and/or the driver's position.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a top view of a vehicle depicting a parking assist system in accordance with the teachings of the present disclosure;

FIG. 2 is a partial perspective interior view of the vehicle of FIG. 1;

FIG. 3 is a schematic view of the parking assist system in accordance with the teachings of the present disclosure;

FIG. 4 is a top view of a seat employing an embodiment of the parking assist system;

FIG. 5 is a side view of a seat employing an embodiment of the parking assist system;

FIG. 6 is a front view of a steering wheel employing an embodiment of the parking assist system;

FIG. 7 is a partial cross-sectional perspective view of the steering wheel of FIG. 6;

FIGS. 8a and 8b are exemplary views illustrating various overhand gripping positions and corresponding gripping profiles on the steering wheel of FIG. 6;

FIGS. 9a and 9b are exemplary views illustrating various underhand gripping positions and corresponding gripping profiles on the steering wheel of FIG. 6; and

FIG. 10 is a table of indicator activation patterns of indicators that are disposed in various components of the vehicle and that are activated in the various components according to a position of a detected object relative to the vehicle.

### DETAILED DESCRIPTION

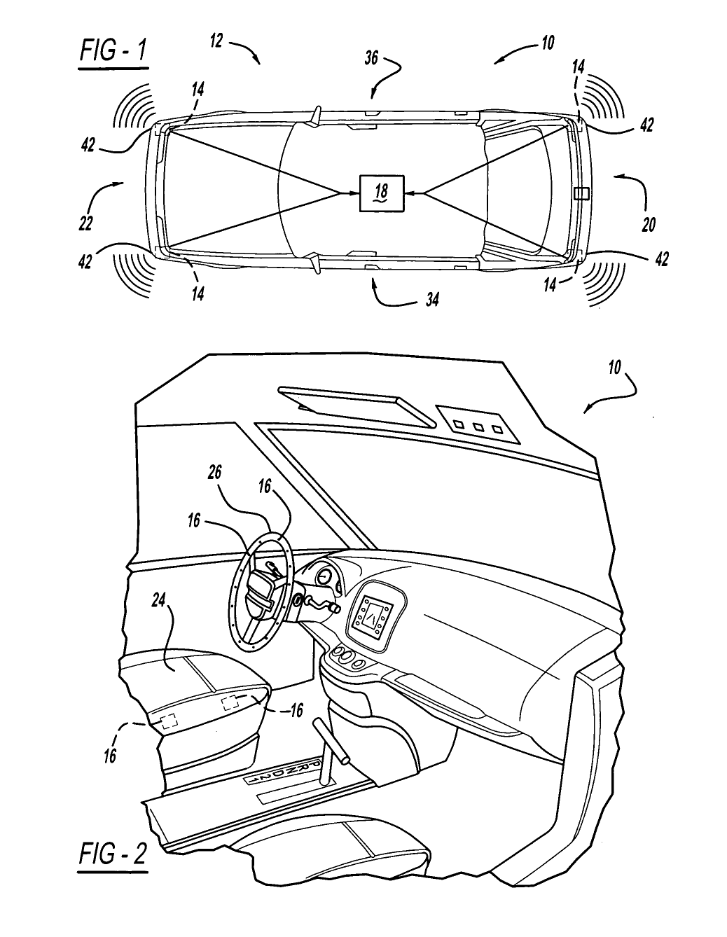

The following description is merely exemplary in nature and is not intended to limit the present disclosure, application, or uses. With reference to FIGS. 1-3, a vehicle 10 is depicted employing a parking aid system 12 that may detect an object proximate to and around (e.g. the vehicle perimeter) a vehicle 10 and may indicate a position of the detected object, relative to the position or periphery of the vehicle 10, to a driver of the vehicle 10. In one embodiment, the parking aid system 12 may include at least one sensor 14 and an indicator 16 communicating with an electronic control unit (ECU) 18. The sensor 14 may detect an object around or near a periphery of the vehicle 10 and communicate with the ECU 18 when the object is detected. The ECU 18 may then activate the indicator 16 to alert the driver of the vehicle 10 as to the position of the object relative to the vehicle or the driver. The parking aid system 12 may be part of a more comprehensive object detection or parking aid system, which may include additional features, such as an audio warning system and a visual warning system.

The sensor 14 may be a device to detect an object and to determine (e.g. measure and compute) a distance of the object from the vehicle 10 or sensor 14. The sensor 14 may be an ultrasonic sensor or a camera, such as a digital camera, or a range (distance) detecting device. The sensor 14 may be mounted to and directed away from the vehicle 10 to detect objects that are within a calculable distance from the vehicle 10. Still yet, the sensor 14 may be orientated to detect objects in areas surrounding the vehicle 10 that may be difficult for the driver to see, such as those areas that are known as “blind spots,” that are present when the driver is inside the vehicle 10 and in a driver's seated position. For example, the sensor 14 may be mounted near or at a rear 20 of the vehicle 10, or near or at a front 22 of the vehicle 10, and may be directed or pointed to detect objects that may or may not be obscured by a trunk, tailgate, hood, body panel, vertical pillar, or other part of the vehicle 10. Additionally, multiple sensors 14 may be disposed around a periphery, for example, of the vehicle 10 to detect objects simultaneously from multiple areas around the vehicle 10. The sensor 14 or sensors may send a signal or signals to the ECU 18 after detecting the object or objects.

The indicator 16 may be a device suitable to alert the driver of the vehicle 10, by way of tactile communication with the driver, when the ECU 18 activates the indicator 16. The indicator(s) 16 may be advantageously disposed in a component of the vehicle 10 that may commonly be in physical contact with the driver when the driver is operating the vehicle 10. More specifically, the indicators 16 may be in a seat 24 and/or a steering wheel 26 of the vehicle 10. In this regard, mechanical vibrators may be particularly well suited as indicators 16, as mechanical vibrators may be disposed within vehicle components such as a seat or a steering wheel and may vibrate the vehicle component so that the driver feels the vibration. In this manner, the vibrating vehicle component may tactilely indicate to the driver that the object has been detected. For example, the indicator 16 disposed in the steering wheel 26 may vibrate the steering wheel 26 to provide tactile feedback to the driver through the driver's hands. Similarly, the indicator 16 disposed in the seat 24 may vibrate the seat 24 to provide tactile feedback to the driver through the driver's legs, torso, back, shoulders, etc.

The ECU 18 may receive an input signal from the sensor 14 when the object is detected and may generate an output signal to activate the indicator 16. The ECU 18 may control the output signal such that the indicator 16 responds in a manner proportionate to a distance between the detected object and the vehicle 10. For example, the ECU 18 may increase a strength of the vibrations generated by the indicator 16 as the vehicle gets closer to the detected object. In another example, vibrations from the indicator 16 may be intermittent and the ECU 18 may increase a frequency at which the intermittent vibrations occur as the vehicle 10 (sensor 14) gets closer to the detected object outside of the vehicle 10. The ECU 18 may provide additional functions, such as permitting the driver to control a strength (strong or light as felt by a driver) of vibrations from the indicator 16 or completely disable (turn off) the indicators 16. Further, the ECU 18 may be used to control the audio and visual features related to the object detection of the sensors 14 if the parking aid system 12 includes such additional features. Further still, in particular embodiments of the parking aid system 12 that will be discussed later in greater detail, the ECU 18 may activate one of or a plurality of indicators 16 in a predetermined or prescribed manner to indicate a general location of the detected object based on the location of the sensor 14 that has detected the object and sent the input signal to the ECU 18.

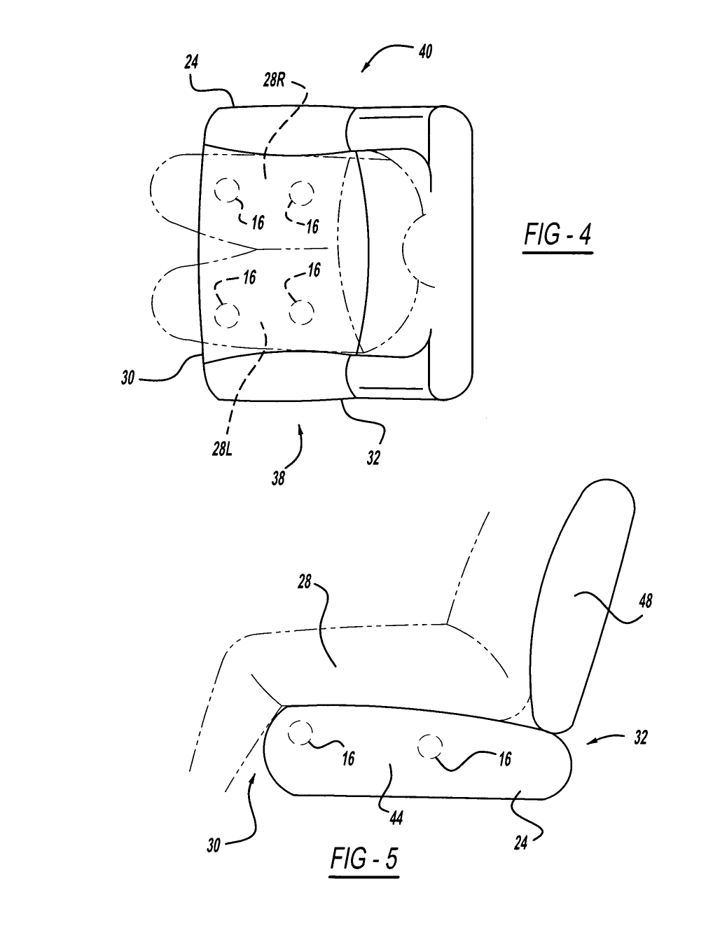

With reference now including FIGS. 4 and 5, an additional aspect of the parking aid system 12 is depicted and may be utilized to indicate a general location of a detected object. In this regard, the parking aid system 12 may include a plurality of sensors 14 arranged around the periphery of the vehicle 10 and a plurality indicators 16 disposed in the seat 24. The indicators 16 may be advantageously arranged in a relative pattern generally corresponding to the locations of the sensors 14. That is, for example, if there is one sensor 14 mounted at each corner of the vehicle 10, then one indicator may be mounted or imbedded at each corner, or proximate each corner, of the seat bottom cushion (or top, seat back cushion) of the seat 24. Further, the indicators 16 may be disposed proximate the legs 28 of the driver (shown in phantom) seated in the seat 24, such as in a seat bottom cushion, such that the driver can differentiate the location of each of the indicators 16 when the indicators 16 are individually activated. For example, the vehicle 10 may include the sensor 14 mounted on the front 22 of the vehicle 10 and another sensor 14 mounted on the rear 20 of the vehicle 10. Corresponding indicators 16 may be mounted near a front 30 of the seat 24 and a rear 32 of the seat 24. Arranged in this manner, the ECU 18 may activate the relatively positioned indicator 16 that corresponds to the sensor 14 that has detected the object. As an example, when the sensor 14 at the front 22 (left or right) of the vehicle detects an object, the ECU 18 may activate the corresponding indicator 16 disposed near the front 30 (left or right) of the seat 24. The activated front indicator 16 may vibrate to notify the driver that the object has been detected at the front 22 of the vehicle 10, such as at the left front or right front of the vehicle 10. In a similar manner, the sensors 14 may be mounted on, or along, left and right sides 34, 36 of the vehicle 10, and corresponding indicators 16 may be mounted on left and right sides 38, 40 of the seat 24, such as the seat bottom cushion.

In one arrangement depicted in FIGS. 4 and 5, a sensor 14 (e.g. only one) is disposed at each corner 42 of the vehicle 10, and four indicators 16 are disposed in a generally rectangular pattern in a seat bottom cushion 44 of the seat 24. Positioned in this manner, each indicator 16 in the seat bottom cushion 44 may directly correspond to a corner 42 of the vehicle 10, each corner 42 having a sensor 14. Further, each indicator 16 may be generally aligned with the legs of the driver such that the indicators 16 forming one lateral side of the rectangular pattern are generally aligned with front and rear portions of the driver's right leg 28R and the indicators 16 forming the other lateral side are generally aligned with forward and rear portions of the driver's left leg 28L. While the indicators 16 are depicted as being disposed in the seat bottom cushion 44 of the seat 24, it will be appreciated that the indicators 16 may alternatively be disposed in a seat back 48 of the seat 24. It will further be appreciated that some indicators 16 may be disposed in the seat bottom cushion 44 and some indicators may be disposed in the seat back 48. Accordingly, one can envision a variety of patterns in which the indicators 16 may be disposed in the seat, but depending upon how corresponding sensors are arranged about the periphery of the vehicle 10. Regardless of how any indicator 16 is arranged, a driver will have the ability to distinguish between the location of each indicator 16 regardless of how the indicators are activated (one or more activated at the same time). Distinguishing between the location of each indicator may be determining the relative location between activated indicators or distinguishing the absolute or independent location of a single activated indicator.

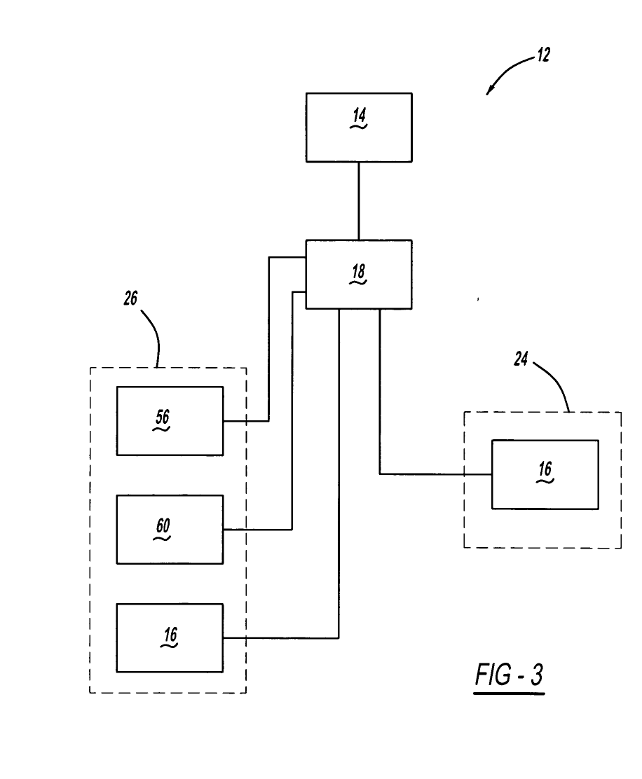

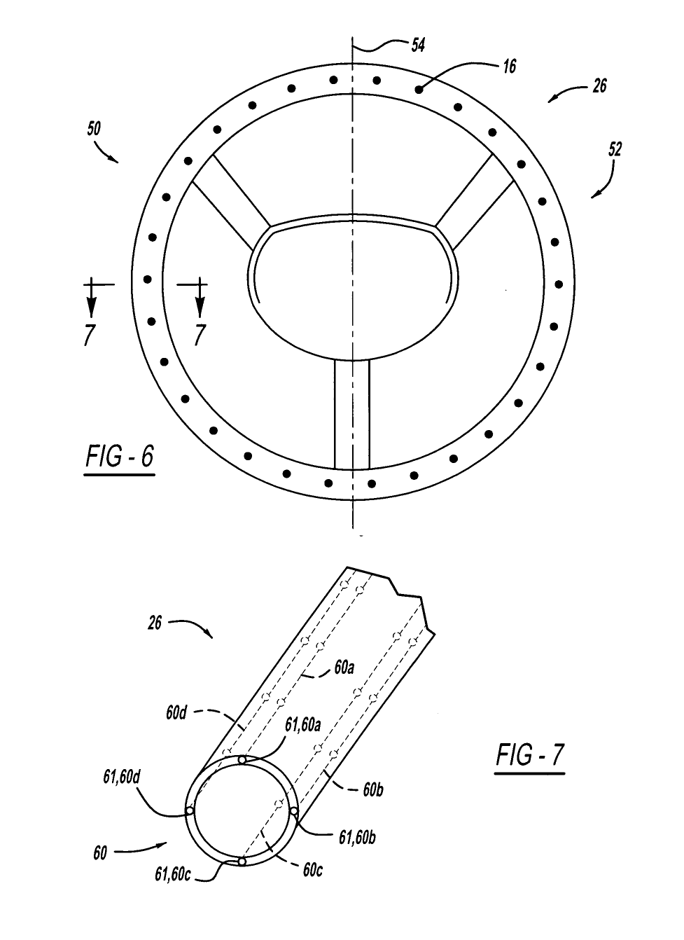

With reference now including FIG. 6, another aspect of the parking aid system 12 is depicted and may be utilized to further indicate a general or specific location of a detected object or objects. In this regard, the parking aid system 12 may include a plurality of sensors 14 arranged around the periphery of the vehicle 10 and a plurality of indicators 16 disposed in the steering wheel 26 of the vehicle 10. One sensor 14 may be disposed at each corner 42 of the vehicle 10, and indicators 16 may be arranged around a periphery of the steering wheel 26, which generally includes a left side 50 and a right side 52 separated by a generally vertical plane 54 extending through a center of the steering wheel 26. An angle sensor 56 (FIG. 3) connected to the steering wheel 26 and communicating with the ECU 18 may provide relative angular position data to the ECU 18 for determining which indicators 16 are on the left and right sides 50, 52, respectively, for a particular rotated position of the steering wheel 26 as the steering wheel is turned as the vehicle 10 is driven. The left side of the steering wheel is that half of the steering wheel that is to the left of a plane or line drawn vertically while viewing the steering wheel from a driving position and the right side of the steering wheel is the right side of such a vertical line or plane. The sensors 14 on or along the left side 34 of the vehicle 10 generally correlate to the indicators 16 disposed on the left side 50 of the steering wheel 26, while the sensors 14 on or along the right side 36 of the vehicle 10 generally correlate to the indicators 16 disposed on the right side 52 of the steering wheel 26. Arranged in this manner, the ECU 18 may selectively operate in a first mode to activate the indicators 16 on the left side 50 or the right side 52 of the steering wheel 26 that correspond to the sensor 14 that has detected an object proximate the vehicle 10 on either the left side 50 or the right side 52 of the vehicle 10. For example, when one of the sensors 14 on the right side 36 of the vehicle detects an object, the ECU 18 may activate the indicators 16 that are currently disposed on the right side 52 of the steering wheel 26, which may vibrate to notify the driver of the detected object.

It should be noted, however, that the driver's right and left hands 58L, 58R, respectively, may not always be positioned on the corresponding right side 52 or left side 50 of the steering wheel 26 while operating the vehicle 10, particularly when parking the vehicle 10. For example, it is common for the left hand 58L to be on the right side 52 of the steering wheel 26 or for the right hand 58R to be on the left side 50 of the steering wheel 26 (i.e., hand cross-over) due to rotational displacements of the steering wheel 26. The driver, however, will typically associate a vibration sensed in the right hand 58R with an object detected on the right side 36 of the vehicle 10, even though the right hand 58R may be gripping the left side 50 of the steering wheel 26. Without adjusting for this cross-over, the driver may be easily confused if indicators 16 proximate to the right hand 58R are activated to indicate the object detected on the left side 34 of the vehicle 10. It will be appreciated that the same situation may apply when the left hand 58L crosses over to the right side 52 of the steering wheel 26.

In the arrangement of FIG. 7, a sensor array 60 is provided that may be used by the ECU 18 to operate in a second mode that may compensate, adjust, or take into consideration, a cross-over situation. In the second mode, the ECU 18 may utilize input from the sensor array 60 to identify one of or both of the right hand 58R and the left hand 58L, regardless of the peripheral position of a driver's hands on the steering wheel 26. The sensor array 60 may further be used to determine a peripheral position of each identified hand 58L, 58R on the steering wheel 26, thereby permitting the ECU 18 to selectively activate indicators 16 proximate to one of the hands 58L, 58R. It should be noted that the driver may choose to operate the parking aid system 12 in either the first mode or the second mode.

The sensor array 60 may include a plurality of sensors 60a-60d that may be radially spaced around a cross-sectional perimeter of the steering wheel 26. Each sensor array 60a-60d may extend around the periphery of the steering wheel 26 and be operable to detect communication with portions (e.g. fingers, thumbs, palms, etc.) of the driver's hands 58L, 58R as he or she grips the steering wheel 26. The sensors 60a-60d may send corresponding input signals to the ECU 18 when contacted by the driver's hands 58L, 58R. In this regard, each of the sensors 60a-60d may include a plurality of individual sensors 61 that may be spaced apart around the periphery of the steering wheel 26. The ECU 18 may recognize which individual sensors are generating input signals to determine the peripheral position of the hands 58L, 58R. The sensors 60a-60d may be of a type that may operate as described above, such as pressure sensors, temperature sensors, proximity sensors, etc. that are capable of sensing the presence of a finger, thumb, palm, etc. (i.e. portions of a user's hand).

In an embodiment, each of the sensors 61 are pressure sensors 61 that may sense or activate when a gripping contact or pressure is applied by the respective fingers 62, palm 64, and thumb 66 of each hand 58L, 58R and send input signals to the ECU 18. These components or portions of the hand may create a distinctive pattern of signals generated by the sensor array 60, due to pressures, for example, that may be received by the ECU 18. The ECU 18 may analyze the received signals to identify unique gripping patterns of the left and right hands 58L, 58R. The ECU 18, after determining the hand positions of the left and right hands 58L, 58R may activate the appropriate or corresponding indicators 16 to account for cross-over. For example, the indicators 16 proximate to the left hand 58L may be activated if the object is detected on the left side 34 of the vehicle 10, even when the left hand 58L is gripping the right side 50 of the steering wheel 26. Such may be the case when the steering wheel is turned.

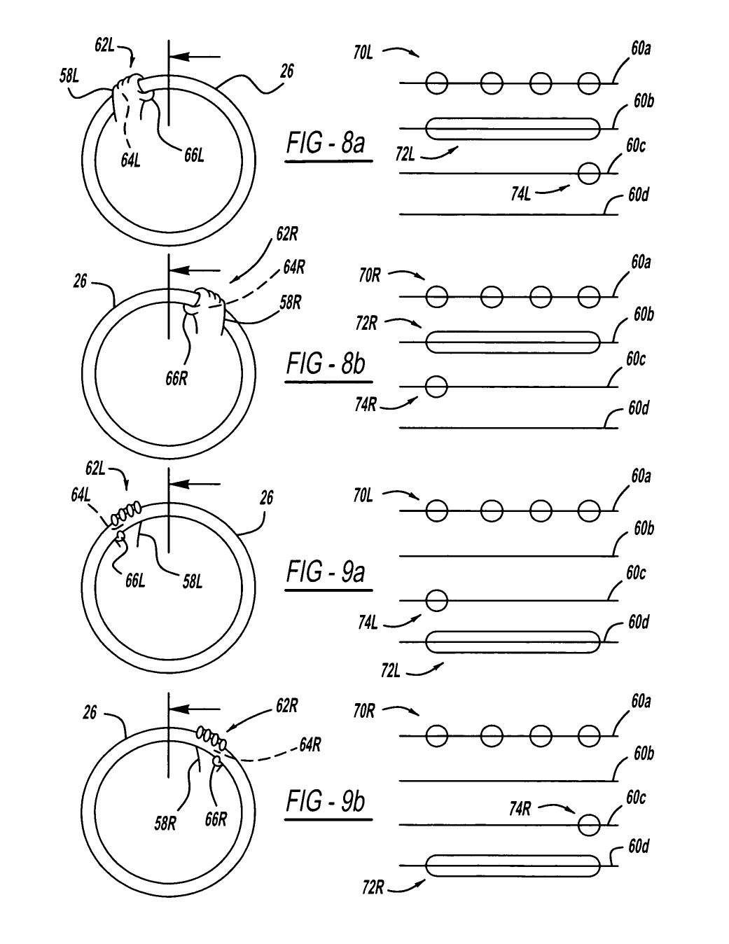

With reference to FIGS. 8a and 8b, various gripping profiles are shown that correspond to common gripping positions of the hands 58L, 58R as they may grip the steering wheel 26. The gripping profiles may be utilized to distinguish the left and right hands 58L, 58R. Reference numerals with an “L” designate a left hand feature while those with an “R” designate a right hand feature. In FIG. 8a, gripping profiles for normal or standard overhand gripping orientations of the right hand 58R and the left hand 58L are depicted. The respective fingers 62L, 62R of each hand 58L, 58R may create a distinct first gripping profile 70L, 70R detected by the sensor array 60a, the respective palm 64L, 64R may create a distinct second gripping profile 72L, 72R detected by the sensor array 60b, and the respective thumb 66L, 66R may create a distinct third gripping profile 74L, 74R detected by the sensor array 60c. However, the third gripping profile 74R for the right thumb 66R may be disposed generally at the left of the first and second gripping profiles 70R, 72R, while the third gripping profile 74L for the left thumb 66L may be disposed generally at the right of the first and second profiles 70L, 72L. The ECU 18 may recognize this distinction in the gripping patterns to differentiate the right hand 58R from the left hand 58L.

In FIGS. 9a and 9b, gripping profiles for underhand gripping orientations of the left hand 58L and the right hand 58R are depicted. The respective fingers 62L, 62R of each hand 58L, 58R may create the first gripping profile 70L, 70R detected by the sensor array 60a, the respective palm 64L, 64R may create the second gripping profile 72L, 72R detected by the sensor array 60d, and the respective thumb 66L, 66R may create a third gripping profile 74L, 74R detected by the sensor array 60c. However, the third gripping profile 74R for the right thumb 66R may be disposed generally at the right of the first and second profiles 70R, 72R, while the third gripping profile 74L for the left thumb 66L may be disposed generally at the left of the first and second profiles 70L, 72L. The ECU 18 may recognize this distinction in the gripping patterns to differentiate the right hand 58R from the left hand 58L as depicted in FIGS. 9b and 9a, respectively. Again, the distinction is made upon hand contact by employing the sensors 61.

Accordingly, when one of the sensors 14 detects an object and sends the input signal to the ECU 18, the ECU 18 may activate the indicators 16 in the steering wheel 26 that are proximate to the peripheral location of the appropriate (i.e. respective) hand 58L or 58R. Alternatively, the ECU 18 may activate the indicators 16 in the steering wheel 26 where the portions of the hands 58L, 58R contact the steering wheel 26 in accordance with the profiles depicted in FIGS. 8a, 8b, 9a and 9b. In this manner, the activated indicators 16 may indicate the general position of the object relative to the right side 36 or the left side 34 of the vehicle 10. For example, when the sensor 14 disposed on the right side 36 of the vehicle 10 detects an object, the ECU 18 may determine the peripheral location of the right hand 58R on the steering wheel 26 and activate the indicators 16 that are proximate to the right hand 58R or that which the right hand 58R is upon or adjacent to.

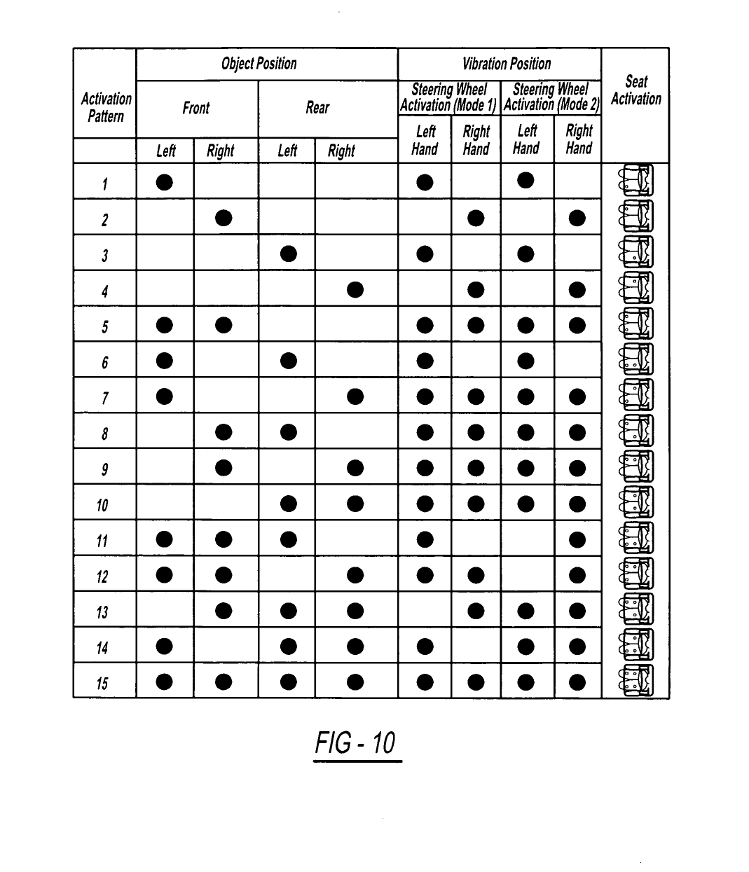

The table of FIG. 10 indicates potential activation patterns of the indicators 16 for the various aspects of the present disclosure. Each activation pattern corresponds to the particular sensor 14 (or sensors) that has detected the object about the perimeter of the vehicle 10. For purposes of this table, the sensors 14 have been disposed at each corner of the vehicle 10. The Object Position columns represent the various combinations in which the sensors 14 may detect the object or multiple objects. The Vibration Position columns represent the resulting activation patterns for the different aspects of the disclosure—Steering Wheel Activation (Mode 1), Steering Wheel Activation (Mode 2), and Seat Activation.

As an example, Activation Pattern #1, in which the sensor 14 at the left and front of the vehicle 10 has detected an object, will be described in greater detail. Regarding Steering Wheel Activation (Mode 1), the ECU 18 may receive input signals from the sensor 14 and from the angle sensor 56 when the parking assist system 12 is operating in the first mode. The ECU 18 may determine which indicators 16 are currently on the left side 50 of the steering wheel 26 based on the current rotational position of the steering wheel 26 and activate all of the indicators 16 on the left side 50. The driver of the vehicle 10 may feel vibrations from the activated indicators 16 through either hand 58L or 58R gripping the left side 50, indicating that the object has been detected on the left side 34 of the vehicle 10.

Regarding Steering Wheel Activation (Mode 2), the ECU 18 may receive input signals from the sensor 14 and from the sensor array 60 when the parking assist system 12 is operating in the second mode. The ECU 18 may determine the peripheral position of the left hand 58L on the steering wheel 26 in the manner previously described and activate the indicators 16 that are proximate to the left hand 58L. The driver may feel vibrations from the activated indicators 16 through the hand 58L gripping the steering wheel 26, indicating that the object has been detected on the left side 34 of the vehicle 10.

Regarding Seat Activation, the ECU 18 may receive input signals from the sensor 14 and activate the indicator 16 at the left-front portion of the seat bottom cushion 44. The driver may feel vibrations from the activated indicator 16 generally disposed near the front portion of the left leg, which may indicate that the detected object is located on the left side 34 and near the front 22 of the vehicle 10.

In accordance with the above description, a method of communicating a location of an object detected near a vehicle to a driver of the vehicle is disclosed. The method may include the initial step of providing a plurality of sensors around a periphery of the vehicle. In a configuration, one sensor is placed at each corner of the vehicle, as the corners of the vehicle are often “blind spots” that a driver cannot see and that may exist when parking the vehicle. However, a sensor or sensors may be placed anywhere around the vehicle to view objects that the vehicle may strike. The distance from a sensor to an object(s) that the vehicle may potentially strike is limited only to the ability of the sensor to measure such distance or detect the object(s). Detection methods may be ultrasonic, radar, radio frequency or other measuring or sensing techniques.

A second step may include providing a plurality of indicators (e.g. vibrators) in a component of the vehicle. The component may be in contact with the driver and the indicators may be spaced apart in the component such that the driver can determine a position of one indicator relative to the other indicators when one or more indicators are activated. In one aspect, the indicators are disposed in a seat and positioned in a generally rectangular pattern, such that each indicator directly correlates to each corner of the vehicle, each corner including a sensor. In a second aspect, the indicators are disposed in and positioned peripherally around a steering wheel. Indicators disposed in a seat bottom cushion 44, a seat back 48, and a steering wheel 26 are other examples of components that have been previously discussed.

A third step may include detecting an object with one of the sensors, and a fourth step may include selectively activating some of the indicators to communicate a location of the detected object to the driver. For the first aspect, step four may merely involve actuating the indicator that correlates to the particular sensor that detected the object. For the second aspect, step four may first require determining a peripheral position of a hand of the driver on the steering wheel relative to the indicators and activating the indicators that are proximate to the determined position of the hand. In a more advanced method, step four may further include distinguishing the right hand from the left hand by determining a gripping pattern on the steering wheel created by a palm, a thumb, and fingers of the respective hand, as previously discussed in accordance with FIGS. 1-10.

What is claimed is:

1. A parking aid system for a vehicle having a seat and a steering wheel, the parking aid system comprising:
at least one sensor disposed on the vehicle and operable to detect an object around a periphery of the vehicle; and
at least one indicator disposed in a component of the vehicle and associated with the at least one sensor, the component communicating with a driver of the vehicle, the at least one indicator operable to vibrate when the at least one sensor detects the object near the vehicle.

2. The parking aid system of claim 1, wherein the at least one indicator is disposed in the steering wheel of the vehicle.

3. The parking aid system of claim 2, wherein the at least one sensor is a plurality of sensors and one sensor is disposed generally at each corner of the vehicle.

4. The parking aid system of claim 1, wherein the at least one indicator is a plurality of indicators peripherally disposed around the steering wheel.

5. The parking aid system of claim 1, wherein the at least one indicator is disposed in the seat of the vehicle.

6. The parking aid system of claim 5, wherein the at least one sensor includes one sensor disposed generally at each corner of the vehicle and the at least one indicator is disposed in a seat bottom cushion.

7. The parking aid system of claim 6, wherein the at least one indicator is a plurality of indicators disposed in a generally rectangular pattern in the seat bottom cushion and each of indicators is associated with a sensor disposed in a respective corner of the vehicle.

8. The parking aid system of claim 1, wherein the at least one sensor is a plurality of sensors disposed around the periphery of the vehicle, the sensors spaced apart to detect objects on different sides of the vehicle.

9. The parking aid system of claim 8, wherein the at least one indicator is a plurality of indicators spaced apart in the component of the vehicle, each of the indicators selectively operable to vibrate.

10. The parking aid system of claim 9, wherein each of the plurality of indicators is associated with a general position of the detected object.

11. A parking aid system for a vehicle having a steering wheel, the parking aid system comprising:
a control unit;
a plurality of first sensors on the vehicle and communicating with the electronic control unit, each of the first sensors operable to detect an object near the vehicle and send a first input signal to the electronic control unit when the object is detected; and
a plurality of indicators disposed around a periphery of the steering wheel, each of the indicators selectively operable to vibrate when activated by the control unit; and
a second sensor disposed in the steering wheel and communicating with the electronic control unit, the second sensor operable to detect a gripping force and send a second input signal to the electronic control unit when the gripping force is detected,
wherein the electronic control unit is operable to receive the first and second input signals, determine a peripheral position of a hand of the driver on the steering wheel based on the second input signal, and selectively activate the indicators proximate to the peripheral position of the hand when the first sensor detects the object.

12. The parking aid system of claim 11, wherein the second sensor is operable to detect a temperature and send the second input signal to the electronic control unit when the temperature is detected.

13. The parking aid system of claim 11, wherein the second sensor is a plurality of force sensors spaced around a cross-section of the steering wheel.

14. A method of communicating a location of an object detected near a vehicle to a driver of the vehicle, the method comprising the steps of:
(a) providing a plurality of object detection sensors proximate a periphery of the vehicle;
(b) providing a plurality of indicators in a component of the vehicle, the component in contact with the driver, the indicators spaced apart in the component such that the driver can determine a relative position of the indicators when the indicators are activated;
(c) detecting an object with one of the sensors; and
(d) activating the indicators to communicate a location of the object detected by the one of the sensors to the driver, the location based on the relative position of the activated indicators.

15. The method of claim 14, wherein step (b) includes providing the indicators in a steering wheel of the vehicle.

16. The method of claim 15, wherein step (d) includes determining a position of a hand of the driver on the steering wheel relative to the indicators and activating the indicators proximate to the position of the hand to indicate the location of the object detected by the one of the sensors.

17. The method of claim 16, wherein determining the position of the hand includes distinguishing a right hand from a left hand and determining the position of each of the right and left hands on the steering wheel.

18. The method of claim 17, wherein distinguishing the right hand from the left hand includes identifying a gripping pattern of at least one of the right hand and the left hand based on relative positions of a palm, a thumb, and fingers of the hand.

19. The method of claim 14, wherein step (b) includes providing position indicators in a seat of the vehicle.

20. The method of claim 14, wherein step (a) includes disposing one of the sensors in each corner of the vehicle.
